(19) United States
(12) Patent Application Publication
(10) Pub. No.: US 2002/0083423 A1
(43) Pub. Date: Jun. 27, 2002

(54) List scheduling algorithm for a cycle-driven instruction scheduler

(75) Inventors: Alexander Y. Ostanevich, Moscow (RU); Vladimir Y. Volkonsky, Moscow (RU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Elbrus International, Moscow (RU)

(21) Appl. No.: 09/971,858

(22) Filed: Oct. 4, 2001

Related U.S. Application Data
(63) Continuation-in-part of application No. 09/505,657, filed on Feb. 17, 2000.
(60) Provisional application No. 60/120,352, filed on Feb. 17, 1999.
(60) Provisional application No. 60/120,360, filed on Feb. 17, 1999.
(60) Provisional application No. 60/120,361, filed on Feb. 17, 1999.
(60) Provisional application No. 60/120,450, filed on Feb. 17, 1999.
(60) Provisional application No. 60/120,461, filed on Feb. 17, 1999.
(60) Provisional application No. 60/120,464, filed on Feb. 17, 1999.
(60) Provisional application No. 60/120,528, filed on Feb. 17, 1999.
(60) Provisional application No. 60/120,530, filed on Feb. 17, 1999.
(60) Provisional application No. 60/120,533, filed on Feb. 17, 1999.

(51) Int. Cl. G06F 9/45

(52) U.S. Cl. 717/149

(57) ABSTRACT

A method for scheduling a plurality of operations of one or more types of operations including a plurality of computing resources is provided. The method includes building a list of partial lists for the one or more types of operations where the partial lists include one or more operations. A current partial list of a type of operation is determined. A computing resource for an operation in the current partial list is then allocated. The method then determines if additional computing resources for the type of operation are available for the current partial list. If so, the method reiterates back to determining a current partial list. If additional computing resources are not available, the method performs the steps of excluding the current partial list from the list and if the list includes any other partial lists, reiterating back to determining a current partial list.

### CROSS-REFERENCES TO RELATED APPLICATIONS

This application is Continuation-In-Part application which is related to and claims priority from U.S. patent application Ser. No. 09/505,657 filed Feb. 17, 2000 which claims priority from U.S. Provisional Patent Application Nos. 60/120,361; 60/120,360; 60/120,352; 60/120,450; 60/120,461; 60/120,464; 60/120,528; 60/120,530; and 60/120,533, all of which were filed Feb. 17, 1999, the disclosures of which are incorporated herein by reference in their entirety.

### BACKGROUND OF THE INVENTION

The present invention generally relates to computing processing and more specifically, to a system and method for instruction scheduling.

As computing architectures, such as Explicit Parallel Instruction Computing (EPIC) platforms, evolve toward increased instruction level parallelism, modern optimizing compilers have become more sophisticated programs enabling optimization of a target source code or initial source code. One of the responsibilities of a compiler is increasing the performance of software code. Using the compiler, parallelism in the initial source code being compiled is analyzed, extracted, and explicitly reflected in the target code. In order to perform the compilation, the initial source code is transformed by the compiler into some kind of Intermediate Representation (IR). One tool used to build an IR is a Dependence Flow Graph (DFG), which is a set of nodes that represent elementary operations in a set of directed edges that couple operations that are dependent on one another. Thus, when two operations are not connected by an edge, the operations may be potentially parallel. However, if two operations are connected by an edge, the operations are dependent on one another.

When building a parallel IR, a code generator produces an explicitly parallel code by means of instruction scheduling. An objective of this stage is to obtain a target code of the original program that executes in the least amount of time (in clock cycles). Instruction scheduling may be performed using two different schemas: time driven and operation driven schedulings. Both schemas project a set of operations/dependencies into a space of time/resources. Time is determined by target processor clock cycles and resources are determined by processor resources, such as arithmetic logic units (ALUs), memory ports, etc.

In the time driven schema, a current clock cycle is fixed. A set of ready operations is built where the set is typically a list of nodes in the IR. Resources (if available) are then subscribed for every operation in the ready list. Using the ready list, a scheduler schedules an operation when it is ready, i.e, when all of the ready operations predecessors have already been scheduled at previous clock cycles and their execution latencies have expired. In the operation driven schema, a current operation is fixed and a proper free slot in the time/resource space is scheduled for the current operation.

Platform specific optimizations designed by architectures, such as EPIC platforms, are based on operation speculation and operation predication, which are features supported by hardware and used by a compiler to create highly parallel target code. Optimizations known in the art, such as modem global and interprocedural analysis, profile feedback, and other techniques, aggressively extract potential parallelism from the source code. These techniques lead to a large ready list of operations in the instruction scheduling phase that slow down compilation speeds. The slow down may be a product of two factors: target hardware parallelism (a number of ALUs available every clock cycle) and a parallelism of the initial IR (a number of nodes in a ready list).

FIG. 1 illustrates a typical method for compiling source code. In step S1, source code is developed. In step S2, the source code is fed to a front end component responsible for correct syntax and lexical structure of the source code depending on the programming language. If the syntax and lexical structure is correct, an initial Intermediate Representation (IR) is produced (step S3). An IR of the source code may be broken into a number of Basic Blocks (BBs), which are blocks of straightforward code without branches.

In step S4, an analyzer performs various kinds of analysis of the IR. The result of the analysis is then stored in IR′ (step S5).

In step S6, an optimizer may perform both classical and platform-specific transformations of IR′ to reach more efficient code. The result of the optimization is IR″ (step S7). As a result of the previous steps, the initial structure of the basic blocks have been significantly changed. The BBs have become larger and thicker because they contain more parallel operations. These blocks are called super blocks or hyper blocks.

The next phase of compilation is code generation, where IR″ is converted to a platform specific binary code or object code. Code generation may include code scheduling (step S8), which may use resource tables (step S9). In step S10, the result of code scheduling is outputted.

In step S11, object code is produced by the compilation.

Modern computing architectures, such as EPIC platforms, provide significant instruction level parallelism. Typically, up to 8-15 operations may be issued every clock cycle. These operations are combined by a compiler into explicit parallel groups called wide instructions. Thus, an original program may be scheduled into an extremely fast code by the compiler. Computing architectures, such as EPIC platforms, typically include multiple ALUs of the same type (adder, multiplier, bit wise, logic) that are fully pipelined.

FIG. 2 illustrates an example source code 200 and an intermediate representation Dependence Flow Graph (DFG) 202. Source code 200 includes potentially parallel operations of additions and a multiplication. Specifically, source code 200 is a routine for performing and returning the result of the operations of (a+b)+(c+d)+(e+f)+(g*h). DFG 202 illustrates a possible intermediate representation dependence flow graph of source code 200. As shown, the variables A and B are added together at block ADD1 and variables C and D are added together at block ADD2. The result of ADD1 and ADD2 are added to together in block ADD3. The variables E and F are added together in block ADD4 and the result of ADD4 and the result of ADD3 are added together in block ADD5. Variables G and H are multiplied together in block MUL and the results of MUL and ADD5 are added together in ADD6. The result is then returned. From DFG 202, multiple pairs of operations are potentially parallel, such as ADD1-ADD2, ADD1-ADD4, ADD1-MUL, ADD3-ADD4, ADD3-MUL, ADD4-MUL, ADD5-MUL and ADD5-MUL.

FIG. 3 illustrates a typical flow chart of a conventional list scheduling method. Also, FIG. 4 illustrates a scheduling table 400 showing the list scheduling results of the intermediate representation of source code 200. The method assumes a hypothetical target architecture including an arithmetic logic unit, ALU0, able to execute addition operations and an arithmetic logic unit, ALU1, able to perform multiplication operations. Additionally, it is assumed that all operations have a delay of one clock cycle and all operands are register values (where there is no need for memory access).

Referring to FIG. 3, in step S300, a ready list is built in clock cycle T=0. Typically, the ready list initially includes the operations ADD1, ADD2, ADD4, and MUL. The ready list includes operations currently available for allocation organized from a highest priority to a lowest priority. The multiplication operation is at the end of the list because it is not a very critical operation. The only operation dependent from the MUL operation is the ADD6 operation but the ADD6 operation depends on a long chain of operations, specifically ADD1→ADD3→ADD5. The process checks every operation including the last one in the ready list to determine if operations in the ready list may be scheduled in the current clock cycle. Every operation in the ready list is checked because even though an operation may be low in priority, it still may be possible to schedule the operation. For example, the MUL operation may be scheduled before the ADD2 and ADD4 operations because there are separate addition and multiplication ALUs.

In step S302, the ready list is rewound to the beginning. In step S304, the operation of highest priority from the ready list is retrieved. In step S306, the process determines if a resource is available to perform the operation. If so, the resource is allocated. The operation is also excluded from the ready list (step S308). If the resource is not available, the process goes to the next operation in the ready list (step S310).

In step S312 the process determines if the ready list is finished. If not, the process reiterates to step S304, where the operation of highest priority from the ready list is retrieved.

If the ready list is finished, the process determines if a basic block is finished (step S314). If the basic block is finished, the process and may start over with the next basic block or end.

If the basic block is not finished, the process increments the clock cycle, T=T+1 (step S316). In step S318, a ready list is updated and the process reiterates to step S302, where the ready list is rewound.

Scheduling table 400 illustrates the result of the method illustrated in FIG. 3. As shown, table 400 includes columns of clock cycle T, scheduling attempts, ready list state, result, and resource allocation. Clock cycle T is the current clock cycle. The scheduling attempts column is the number of attempts made to schedule in the process. The ready list state column illustrates the state of the ready list. The operations of the highest priority in the ready list are underlined. The result column illustrates whether or not the current operation of highest priority in the ready list is allocated. The resource allocation column is broken up into two columns of ALU0 and ALU1, and illustrates whether an operation is allocated in either ALU0 or ALU1.

As shown in clock cycle T=0, scheduling attempt one, the operation of highest priority, ADD1, is allocated for ALU0. In scheduling attempts two and three, the scheduler attempts to allocate operations ADD2 and ADD4 unsuccessfully. However, in scheduling attempt four, the MUL operation is allocated in ALU1.

In clock cycle T=1, ADD2 is allocated in ALU0 in scheduling attempt five. For scheduling attempt six, ADD4 is unsuccessfully allocated.

In clock cycle T=2, ADD4 is allocated in ALU0 for scheduling attempt seven and ADD3 is unsuccessfully allocated in scheduling attempt eight.

In clock cycle T=3, ADD3 is allocated for ALU0. In clock cycle T=4, ADD5 is allocated in ALU0. In clock cycle T=5, ADD6 is allocated in ALU0.

Thus, unsuccessful scheduling attempts two, three, six, and eight are redundant scheduling attempts by the scheduler. Because the scheduler must check every operation in the ready list, the redundant operations are necessary.

Resultant schedule 402 illustrates the final schedule as a result of resource allocation. As shown, in clock cycle T=0, ADD1 and MUL operations are allocated. In clock cycle T=1-5, subsequent ADD operations ADD2-ADD6 are allocated for ALU0.

### BRIEF SUMMARY OF THE INVENTION

In one embodiment of the present invention, a method for scheduling operations using a plurality of partial lists is provided. The partial lists include operations organized by a type of operation. Redundant scheduling attempts are avoided by using the partial lists. For example, when a resource is fully subscribed, the partial list including operations for the resource is excluded from attempts to allocate operations from the partial list.

A method for scheduling a plurality of operations of one or more types of operations using a parallel processing architecture including a plurality of computing resources is provided in one embodiment. The method includes building a list of partial lists for the one or more types of operations where the partial lists include one or more operations. A current partial list of a type of operation is determined where operations from the current partial list are allocated. A computing resource for an operation in the current partial list is then allocated.

The method then determines if additional computing resources for the type of operation are available for the current partial list. If so, the method reiterates back to the step where a current partial list is determined. If additional computing resources are not available, the method performs the steps of excluding the current partial list from the list and if the list includes any other partial lists, reiterating back to the step where a current partial list is determined.

A further understanding of the major advantages of the invention herein may be realized by reference to the remaining portions of the specification in the attached drawings.

### BRIEF DESCRIPTION OF THE DRAWINGS

FIG. 1 illustrates a typical method for compiling source code;

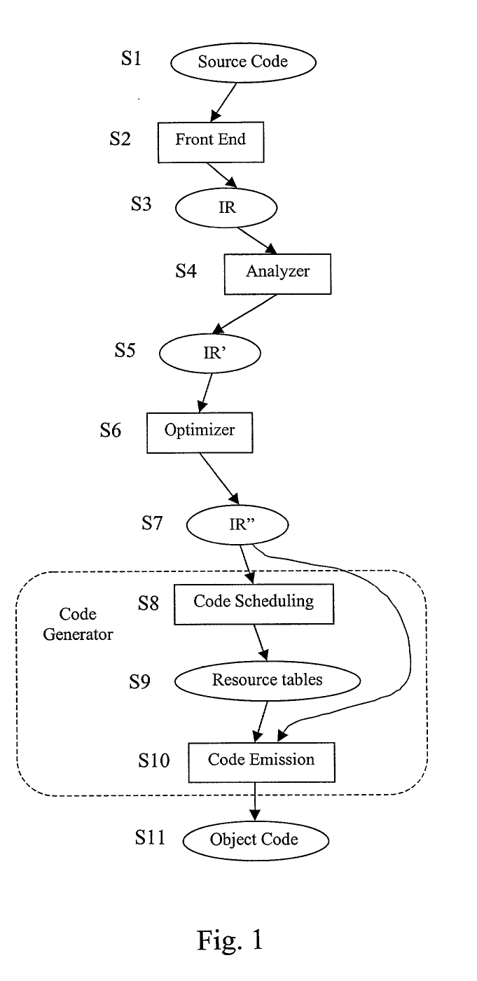

FIG. 2 illustrates an example source code and an intermediate representation dependence flow graph;

FIG. 3 illustrates a typical flow chart of a conventional list scheduling method;

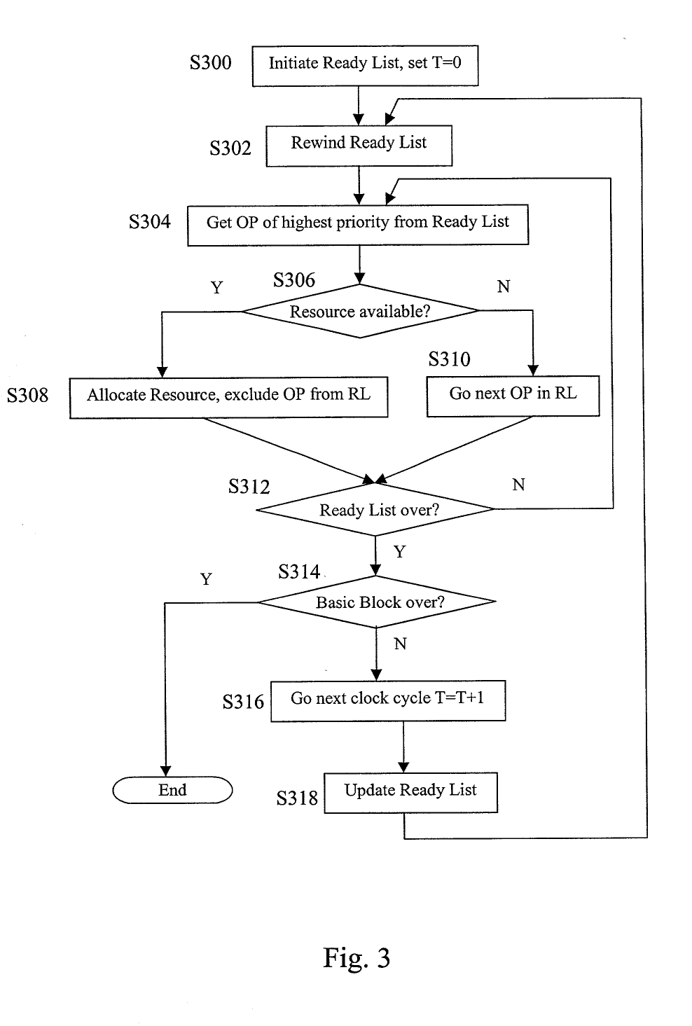

FIG. 4 illustrates a scheduling table showing the list scheduling results of an intermediate representation of the source code;

FIG. 5 illustrates a method for list scheduling according to one embodiment; and

FIG. 6 illustrates a scheduling table for the method of FIG. 5 according to one embodiment.

### DETAILED DESCRIPTION OF THE INVENTION

In one embodiment, the present invention may be used in any processing system that includes parallel processing resources. For example, the Elbrus 2000 computing architecture designed by Elbrus is a computer architecture that provides suitable parallel processing resources for supporting the techniques of the present invention. This architecture is described in detail in, for example, U.S. Pat. No. 5,923,871 and is hereby incorporated by reference for all purposes.

An embodiment of the present invention solves the inefficiencies of traditional instruction schedulers. More specifically, redundant scheduling attempts are avoided. In one embodiment, operations in the ready state are separated by the types of resources necessary to execute the operations. For example, source code 200 includes two types of operations: add and multiply. Thus, a single ready list may be split into several Partial Ready lists (PRL). For example, source code 200 may be split up into two PRLs: PRL1 for additions and PRL2 for multiplications. Further, a hyper list including at least one PRL or at most all PRLs is built. In one embodiment, a priority of each PRL is then established that is equal to a priority of the first operation in the PRLs.

When a resource is fully subscribed in a current clock cycle, a corresponding PRL is excluded from the hyper list until the next instruction. Accordingly, redundant attempts at scheduling may be avoided.

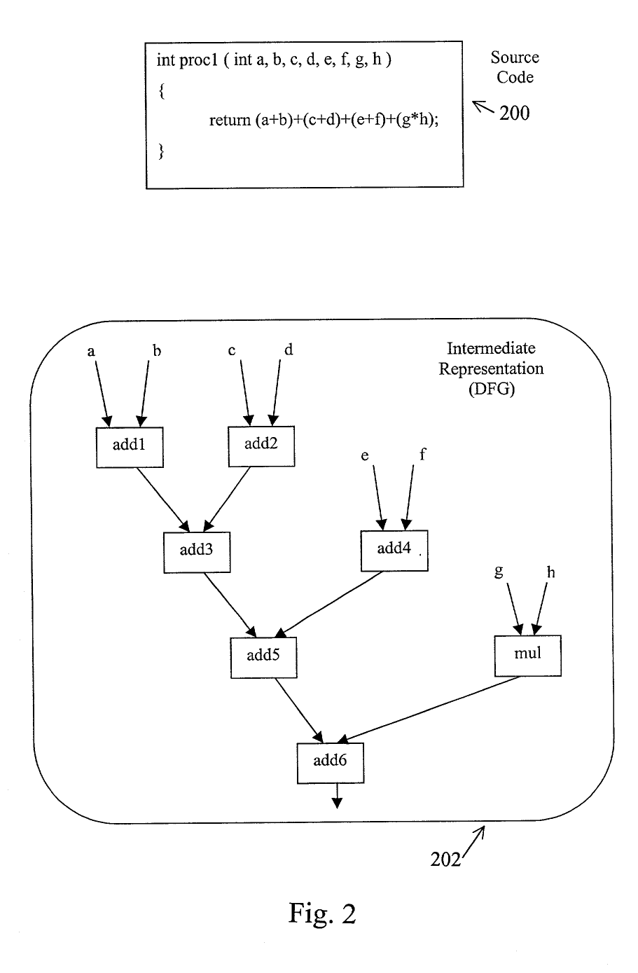

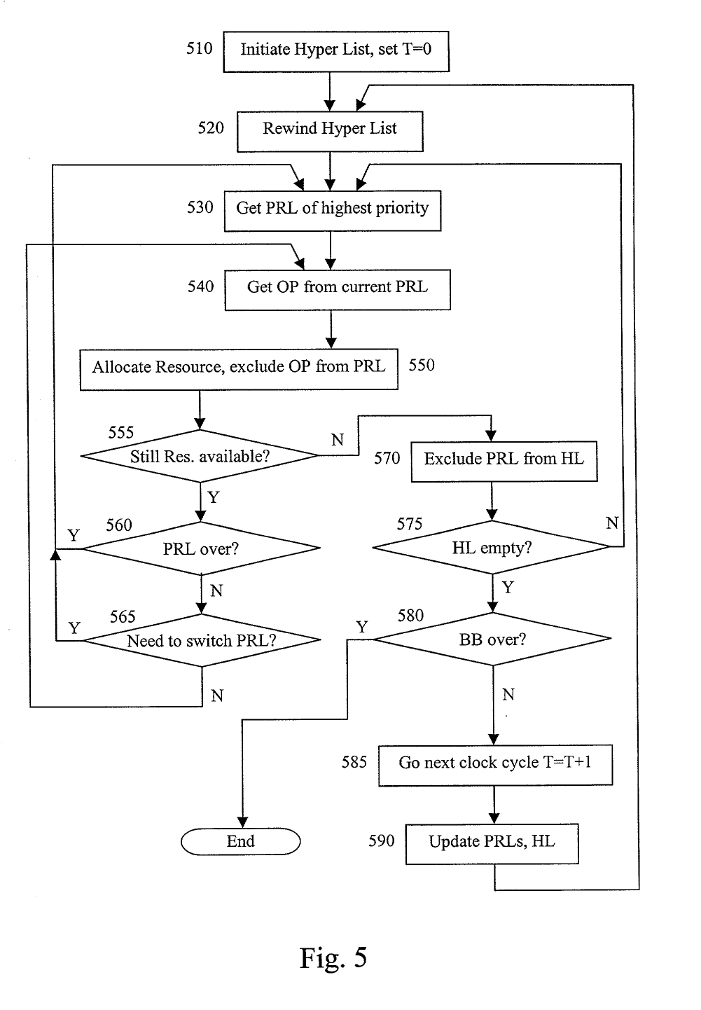

FIG. 5 illustrates a method for list scheduling according to one embodiment. In step S510, hyper lists are initiated at T=0. In one embodiment, the hyper list is subdivided into any number of PRLs. For example, using source code 200 and DFG 202 of FIG. 2, the hyper list may be subdivided into two lists for the two types of operations, add and multiply: PRL1 and PRL2. PRL1 includes the addition operations ADD1, ADD2, ADD3, and ADD4 and PRL2 includes the multiplication operation MUL. Thus, PRL1 is associated with the addition ALU (ALU0) and PRL2 is associated with the multiplication ALU (ALU1). It will be understood that although the same resources assumed in the previous example are used, a person of skill in the art will recognize alternative resources that may be used.

In step S520, the hyper list is rewound. This ensures that the process begins at the top of the hyper list.

In step S530, the PRL of highest priority is retrieved. For example, ADD1 may have a higher priority than MUL because many additional operations are dependent on ADD1. Thus, PRL1 will have a higher priority than PRL2. In one embodiment, priority may be assigned based on the first operation of each PRL. In this case, PRL1 is retrieved first.

In step S540, an operation from the current PRL is retrieved. In this example, ADD1 is retrieved first.

In step S550, an appropriate resource is allocated. Additionally, the allocated operation is excluded from the PRL. For example, the operation may be physically excluded from the PRL or marked in the PRL so the operation is not allocated again. Additionally, the priority of the current PRL is re-assigned. In one embodiment, the priority of the current PRL is based on a new first operation in the current PRL.

In step S555, the process determines if resources are still available for the operation represented by the current PRL.

If there are resources available, in step S560, the process determines if the current PRL is finished. If so, the process iterates back to step S530 to retrieve the next PRL of highest priority. In step S565, if the PRL is not finished, the process determines if the PRL should be switched. If so, the process iterates to step S530, where a PRL of highest priority is retrieved. If the process does not need to switch PRLs, the process iterates to step S540, where an operation from the current PRL is retrieved. In one embodiment, the process switches PRLs if a priority of another PRL other than the current PRL is higher.

If resources are not available, the process proceeds to step S570, where the current PRL is excluded from the hyper list. In step S575, the process determines if the hyper list is empty. If not, the process iterates step S530, where a PRL of highest priority is retrieved. If the hyper list is empty, the process determines if a basic block being processed is finished. If so, the process ends. If not, in step S585, the next clock cycle, T=T+1, is processed. In step S590, the PRLs and the hyper list is updated and the process iterates to step S520.

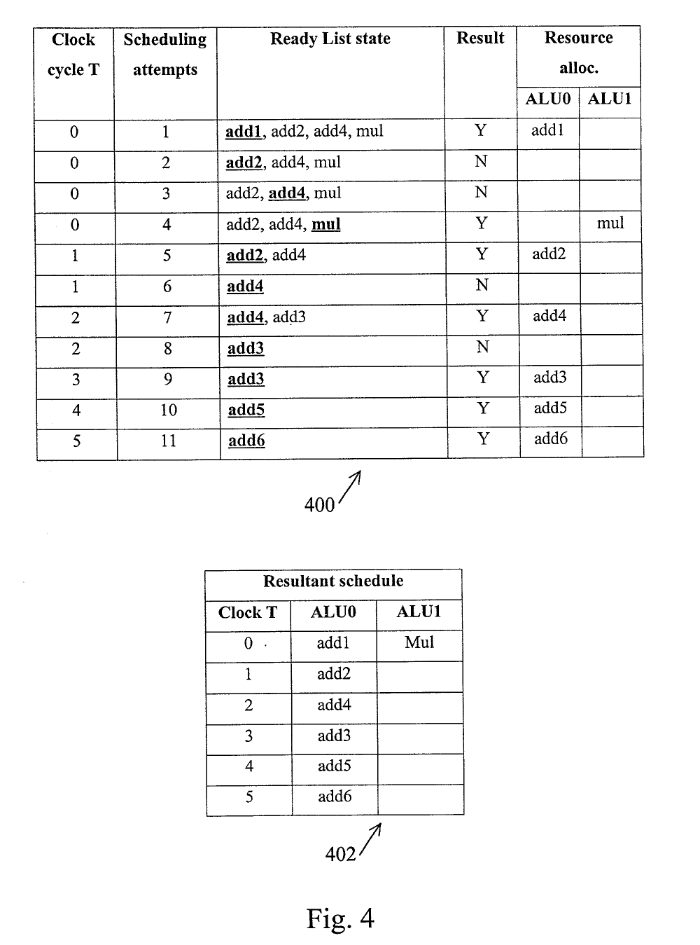

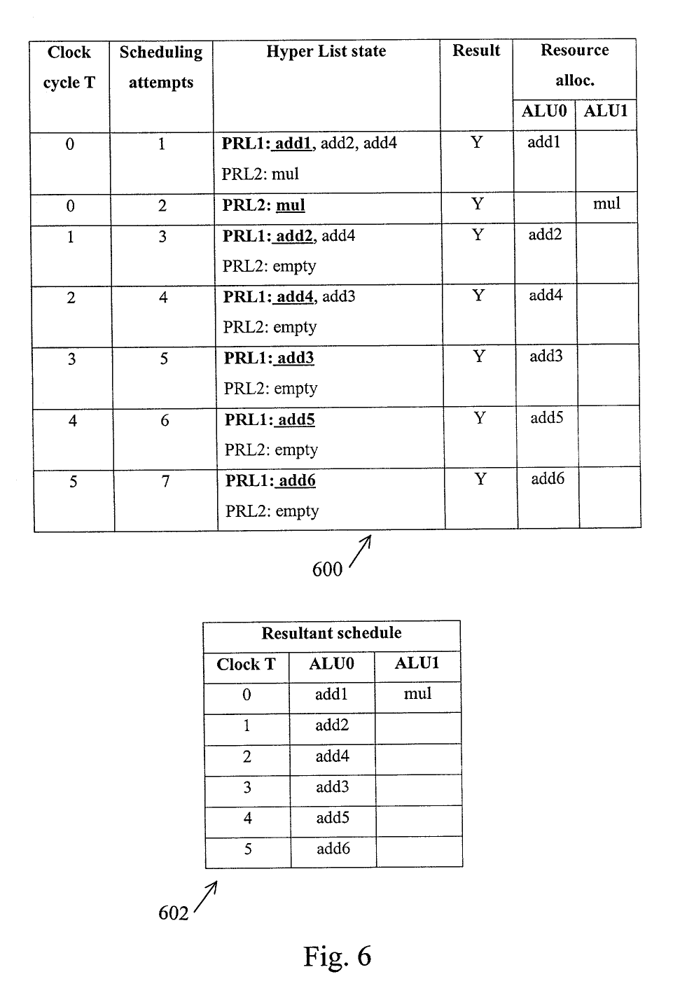

FIG. 6 illustrates a scheduling table 600 for the method of FIG. 5 according to one embodiment. As shown, table 600 includes the columns of scheduling table 400 of FIG. 4. In clock cycle T=0, PRL1 is retrieved first and a first operation ADD1 is allocated in ALU0 (steps S510-S550). The process then determines if the resource is still available and in this case it is not. Thus, the process proceeds to step S570, where the PRL1 is excluded from the hyper list. In step S575, the hyper list is not empty because the hyper list contains PRL2.

The process then iterates to step S530, where PRL2 is retrieved. The MUL operation is retrieved (step S540) and the MUL operation is allocated in ALU1 (step S550). In step S555, the ALU1 resource is now not available. Thus, in step S570, PRL2 is excluded from the hyper list and the hyper list is effectively empty (step S575). The ADD1 and MUL operations were allocated with no redundant scheduling attempts for ADD2 and ADD4.

In step S580, the basic block is not finished and the clock cycle is incremented (step S585). Further, the PRLs and the hyper lists are updated (step S590), and the process iterates to step S520.

As shown, in clock cycle T=1, PRL1 now includes the ADD2 and ADD4 operations and PRL2 is empty. ADD2 is retrieved from PRL1 and the operation and resources are allocated for the operation. During the clock cycle, no redundant scheduling attempts are made for ADD4.

The process then continues at clock cycle T=2, where PRL1 includes ADD4 and ADD3 operations and PRL2 is empty. The process then retrieves ADD4 and allocates ADD4 in ALU0. No further scheduling attempts are made to allocate operation ADD3.

The process then iterates to clock cycle T=3, where PRL1 includes the ADD3 operation and PRL2 is empty. The ADD3 operation is then scheduled in ALU0.

The process then continues to clock cycle T=4 where PRL1 includes the ADD5 operation. The ADD5 operation is then scheduled in ALU0.

The process then iterates to clock cycle T=5, where PRL1 includes the ADD6 operation and PRL2 is empty. The ADD6 operation is then scheduled in ALU0.

As a result, redundant scheduling operations are avoided by the scheduler. For example, PRL1 is excluded from the hyper list when no more additions may be performed. Additionally, after the MUL operation in PRL2 is performed, PRL2 is excluded from the hyper list. Thus, after two scheduling attempts, the process proceeds to clock cycle T=1 without any redundant attempts. Additionally, redundant scheduling attempts found at clock cycles T=1 and T=2 are also avoided.

In an alternative embodiment, if a computer architecture includes multiple equivalent ALUs with identical resources for each type, a counter may be included that is decremented when each scheduling attempt is successful. Thus, when the counter reaches zero, a resource is fully subscribed.

Resultant schedule 602 shows the schedule after operation scheduling. The number of scheduling attempts is reduced from 11 to 7 in scheduling table 600 for the same source code 200 and same hypothetical target architecture. Thus, resultant schedule 602 remains the same as resultant schedule 402 with the number of scheduling attempts reduced from 11 to 7.

The above description is illustrative but not restrictive. Many variations of the invention will become apparent to those skilled in the art upon review of this disclosure. For example, different Register Economy Priority (REP) values may be assigned as long as the operations are ordered to reduce register pressure. Additionally, alternative computer resources may be used and the scope of the invention should, therefore, be determined not with reference to the above description, but instead should be determined with reference to the pending claims along with their full scope or equivalents.

What is claimed is:

1. A method for scheduling a plurality of operations of one or more types of operations using a parallel processing architecture including a plurality of computing resources, the method comprising:
(a) building a list of partial lists for the one or more types of operations, the partial lists including one or more operations from the plurality of operations;
(b) determining a current partial list of a type of operation to allocate from the list of partial lists;
(c) allocating a computing resource for an operation in the current partial list;
(d) determining if additional computing resources for the type of operation are available for the current partial list;
(e) if additional computing resources are available, reiterating to step (b);
(f) if additional computing resources are not available, performing the steps of:
(1) excluding the current partial list from the list;
(2) if the list includes any other partial lists, reiterating to step (b).

2. The method of claim 1, further comprising incrementing a clock cycle to a next cycle.

3. The method of claim 2, further comprising updating the list of partial lists and reiterating to step (b).

4. The method of claim 3, wherein updating the list of partial lists comprises excluding operations allocated from the partial list.

5. The method of claim 1, further comprising assigning a priority to the partial lists.

6. The method of claim 5, wherein assigning the priority comprises assigning the priority based on a priority of an operation in each partial list.

7. The method of claim 5, wherein determining the current partial list of the type of operation to allocate from the list comprises determining the current partial list of a highest priority.

8. The method of claim 1, further comprising excluding the allocated operation from the partial list.

9. The method of claim 1, further comprising assigning a new priority to the plurality of partial lists based on an operation not already allocated in the partial list.

10. A method for scheduling a plurality of operations using a parallel processing architecture including a plurality of computing resources, the method comprising:
(a) building a list of partial lists, the partial lists including one or more operations in the plurality of operations;
(b) assigning priorities to the partial lists;
(c) determining a current partial list with a highest priority;
(d) allocating an available computing resource for an operation in the current partial list;
(e) assigning a new priority to the current partial list;
(f) determining if additional computing resources are available for the current partial list;
(g) if additional computing resources are available, performing the steps of:
(1) determining if the current partial list includes additional operations;
(2) if the current partial list includes additional operations, reiterating to step (d);
(3) if the current partial list does not include additional operations, excluding the current partial list from the list and reiterating to step (c);
(h) if additional computing resources are not available, performing the steps of:
(1) excluding the current partial list from the list;
(2) if the list includes any other partial lists, reiterating to step (c).

11. The method of claim 10, wherein assigning a priority to the partial lists comprises assigning a priority based on an operation in each of the partial lists.

12. The method of claim 10, wherein assigning a new priority to the current partial list comprises assigning a new priority based on an operation not already allocated in the current partial list.

13. The method of claim 10, further comprising excluding the allocated operation from the current partial list.

14. The method of claim 10, further comprising incrementing a clock cycle to a next cycle.

15. The method of claim 14, further comprising updating the plurality of partial lists and the list to reflect the allocated operations.

16. The method of claim 14, further comprising resetting the list.
